(19) United States
(12) Patent Application Publication
(10) Pub. No.: US 2006/0286247 A1
(43) Pub. Date: Dec. 21, 2006

(54) Food product and process for preparing same

(76) Inventor: Costas Ataliotis, Winnipeg (CA)

Correspondence Address: Bliss McGlynn, P.C., Suite 600, 2075 West Big Beaver Road, Troy, MI, 48084, US

(21) Appl. No.: 11/143,687

(22) Filed: Jun. 2, 2005

(51) Int. Cl. A23L 1/00

(52) U.S. Cl. 426/564; 426/569

(57) ABSTRACT

A process for preparing a liquid food product having improved foaming properties. The process comprises adding calcium caseinate S to milk to obtain a cream. The cream is further blended with a food ingredient after being diluted with water. The blended mixture is then subjected to a pasteurizing step followed by a cooling step, after which, gaseous nitrogen is incorporated thereinto. The food product comprises milk, calcium caseinate S, water, a food ingredient, and nitrogen.

### FIELD OF THE INVENTION

The invention relates to a liquid food product having improved foaming properties and to a process for preparing the food product.

### BACKGROUND OF THE INVENTION

Liquid food products capable of generating a large amount of foam are in high demand in the food industry, in particular in the beverage industry. It is also desirable that the generated foam be capable of lasting a relatively long period of time. Various methods of improving foaming properties of liquid food products are known in the art.

One such method is disclosed in U.S. Pat. No. 6,551,636 of Chen, wherein protein preparations, in particular whey protein preparations, are modified to improve foaming properties of food products containing them. U.S. Pat. No. 3,985,902 of Coste teaches a specific way of mixing ingredients including an inert gas, for preparing a food product in the form of a mousse. U.S. Pat. No. 4,438,147 of Hedrick, Jr. discloses a powder-form foaming creamer which is suitable for use in beverages. The preparation of the creamer includes the use of a proteinaceous foam stabilizer such as a caseinate salt, preferably sodium caseinate. U.S. Pat. No. 5,462,759 of Westerbeek et al. also discloses a powder-form foaming creamer preparation suitable for use in beverages such as coffee and soups. A proteinaceous foam stabilizer involved in the preparation includes chicken's egg-albumen.

There is still a need for a liquid food product that has improved foaming properties and that can be readily used without any further preparation.

### SUMMARY OF THE INVENTION

According to a first aspect, the invention provides a process for preparing a liquid food product having improved foaming properties. The process comprises the steps of: (a) adding calcium caseinate S to milk to obtain a cream; (b) diluting the cream with water to obtain a milky mixture (c) blending the milky mixture with at least one food ingredient selected from the group consisting of coffee, cocoa, alcohol and food flavour; (d) pasteurizing the blended mixture at a temperature between about 120° C. to about 160° C.; (e) cooling the pasteurized mixture to a first cooling temperature between about −10° C. to about 10° C.; and (f) incorporating nitrogen into the cooled mixture to obtain the food product.

The generated milky mixture may be homogenized prior to blending.

According to a second aspect, the invention provides a liquid food product having improved foaming properties. The food product comprises: a blended mixture of milk, calcium caseinate S and water; at least one food ingredient selected from the group consisting of coffee, cocoa, alcohol and food flavour; and nitrogen.

The term “about” as used herein, will be understood by persons of ordinary skill in the art and will vary on the context in which it is used. In the case the use is not clear to persons of ordinary skill in the art given the context in which it is used, “about” will mean up to plus or minus 10% of the particular term.

### DETAILED DESCRIPTION OF THE INVENTION

It has been found that incorporating nitrogen into a blended mixture comprising milk, calcium caseinate S, and a food ingredient, which mixture is pasteurized then cooled, provides a liquid food product having improved foaming properties. In particular, the food product prepared using this method is capable when exposed to atmospheric oxygen, to generate a foam product having a volume which is about double to four times its original volume. The foam product can last for as long as about 10 to 20 minutes.

The foamed food product can be used right away, or may be placed into relatively small packages for future use. Before storing the packages, they are sterilized at a sterilization temperature which can be between about 100° C. to about 140° C., preferably about 120° C. The sterilization process can last for about 10 to 30 minutes, preferably 20 minutes. The food product in the packages is thereafter cooled to about 20° C. to 30° C., preferably to about 25° C.

Such packages can be bottles or cans of various sizes and shapes depending on the intended use. The content of each bottle or can will be for a single use, since the food product spontaneously generates foam upon contact with atmospheric oxygen when the bottle or can is opened.

The type of milk used in the process according to the invention may have cream fat present in a range of about 0% to about 15% by weight, preferably in a range of about 70% to about 8% by weight.

The proteinaceous material, calcium caseinate S, preferably in powder form, is added to milk in an amount of about 1.0 gram to about 1.8 grams, preferably about 1.4 grams per 100 ml of milk. The addition is performed at a temperature between about 15° C. to about 25° C., preferably at a temperature between about 18° C. to about 22° C. The cream generated is then diluted with water to yield a milky mixture. Water used for the dilution may be in a range of about 0.6 to about 1.5 times the amount of milk, preferably about 1.1 times. The milky mixture may be further subjected to a homogenizing step prior to adding the food ingredient. Such homogenizing step can be performed through a series of at least two homogenizers, preferably four, and at room temperature.

The preferred proteinaceous material used in the process is calcium caseinate S. However, it is to be understood that other suitable proteins will be apparent to persons skilled in the art. Such proteins may be used in the process without departing from the spirit and scope of the invention. Preferably, calcium caseinate S is used in powder form.

The generated milky mixture is further blended with at least one food ingredient which can be coffee, cocoa, alcohol or a food flavour. The food flavour may be caramel, vanilla, honey, fruit, maple or mixtures thereof. When the food ingredient is alcohol, its content in the final food product can be between about 4% to about 120% by volume.

The blended mixture is further pasteurized at a temperature between about 120° C. to about 160° C., preferably at about 140° C. The pasteurizing step is carried out in a relatively brief period of time, less than 1 minute, preferably between about 30 to 45 seconds. Then the mixture is cooled to a temperature between about −10° C. to about 10° C., preferably to about 0° C.

Nitrogen is incorporated into the cooled mixture. This step is carried out at about 0° C. The amount of nitrogen used is in an order of between about 4 grams to 8 grams, preferably about 6 grams, per liter of the blended mixture. A person skilled in the art will understand that other ingestible inert gases or mixtures thereof may be suitable for use in the process without departing from the spirit and scope of the invention.

The invention thus provides a liquid food product which has improved foaming properties, and which is prepared in accordance with the process described above. The food product comprises a blended mixture comprising milk, calcium caseinate S and at least one food ingredient. Nitrogen is incorporated into the blended mixture. The food ingredient can be coffee, cocoa, alcohol, a food flavour or mixtures thereof. The food flavour can be any type of natural or artificial food flavour generally used in the food industry, such as caramel, vanilla, honey, fruit, maple or mixtures thereof.

The inert gas, nitrogen, is present in the food product in an amount between about 4 grams to 8 grams, preferably about 6 grams, per liter of the blended mixture.

When the food ingredient in the food product according to the invention, is alcohol, its content in the final product is between about 4% to about 120% by volume.

### EXAMPLE 1

6.3 grams of calcium caseinate S is added to 450 ml of milk. The cream obtained is diluted with 478 ml of water to yield a milky mixture. The milky mixture is homogenized, then blended with 52 ml of alcohol, 5 ml of flavour, 10 ml of coffee extract, and 5 ml of caramel colour. The blended mixture is pasteurized at a temperature of about 140° C. for a period of about 40 seconds, then cooled to about 0° C. Gaseous nitrogen, in an amount of about 6 grams is incorporated into the resulting cooled mixture to obtain a liquid food product.

### EXAMPLE 2

The food product prepared in Example 1 is distributed into bottles or cans of about 200 ml to 375 ml, which are then closed. The bottles or cans are sterilized at a temperature of about 120° C. for a period of about 20 minutes, then they are cooled to about 25° C.

While the invention has been described in conjunction with preferred embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What I claim as my invention:

1. A process for preparing a liquid food product having improved foaming properties, comprising the steps of:
(a) adding calcium caseinate S to milk to obtain a cream;
(b) diluting the cream with water to obtain a milky mixture;
(c) blending the milky mixture with at least one food ingredient selected from the group consisting of coffee, cocoa, alcohol and food flavour;
(d) pasteurizing the blended mixture at a temperature between about 120° C. to about 160° C.;
(e) cooling the pasteurized mixture to a first cooling temperature between about −10° C. to about 10° C.; and
(f) incorporating gaseous nitrogen into the cooled mixture to obtain the food product.

2. The process according to claim 1, wherein the milky mixture obtained in step (b) is homogenized prior to blending.

3. The process according to claim 1, wherein the food product obtained in step (f) is placed into small packages, and the packages are sterilized at a sterilization temperature between about 100° C. to about 140° C. for a period of about 10 to 30 minutes, then the food product is cooled to a second cooling temperature of about 20° C. to about 30° C.

4. The process according to claim 1, wherein the milk has a cream fat content of about 0% to about 15% by weight.

5. The process according to claim 1, wherein the milk has a cream fat content of about 7% to about 8% by weight.

6. The process according to claim 1, wherein calcium caseinate S in powder form is added to milk in an amount of about 1.0 gram to about 1.8 grams per 100 ml of milk.

7. The process according to claim 1, wherein calcium caseinate S in powder form is added to milk in an amount of about 1.4 grams per 100 ml of milk.

8. The process according to claim 1, wherein water used for dilution is in an amount of about 0.8 to about 1.5 times the amount of milk.

9. The process according to claim 1, wherein water used for dilution is in an amount of about 1.1 times the amount of milk.

10. The process according to claim 1, wherein nitrogen is incorporated in an amount between about 4 grams to 8 grams per liter of the blended mixture.

11. The process according to claim 1, wherein nitrogen is incorporated in an amount of about 6 grams per liter of the blended mixture.

12. The process according to claim 1, wherein the addition of calcium caseinate S to milk is performed at a temperature between about 18° C. to about 22° C.

13. The process according to claim 1, wherein the pasteurizing step is performed at a temperature of about 140° C.

14. The process according to claim 1, wherein the first cooling temperature is about 0° C.

15. The process according to claim 1, wherein the step of incorporating nitrogen is performed at a temperature of about 0° C.

16. The process according to claim 3, wherein the sterilization temperature is about 120° C. and the sterilization period is 20 minutes.

17. The process according to claim 3, wherein the second cooling temperature is about 25° C.

18. The process according to claim 1, wherein the food flavour is selected from the group consisting of caramel, vanilla, honey, fruit, maple and mixtures thereof.

19. The process according to claim 1, wherein the food ingredient is alcohol.

20. The process according to claim 19, wherein the food product has an alcohol content between about 40% to about 120% by volume.

21. A process for preparing a liquid food product having improved foaming properties, comprising the steps of:
(a) adding calcium caseinate S to milk to obtain a cream;
(b) diluting the cream with water to obtain a milky mixture;
(c) homogenizing the milky mixture;
(d) blending the homogenized mixture with at least one food ingredient selected from the group consisting of coffee, cocoa, alcohol and food flavour;
(e) pasteurizing the blended mixture at a temperature between about 120° C. to about 160° C.;
(f) cooling the pasteurized mixture to a first cooling temperature between about −10° C. to about 10° C.;
(g) incorporating nitrogen into the cooled mixture to obtain the food product;
(h) distributing the food product into small packages;
(i) sterilizing the packages at a sterilizing temperature between about 100° C. to about 140° C.; and
(j) cooling the food product to a second cooling temperature between about 20° C. to about 30° C.

22. A liquid food product having improved foaming properties, comprising:
a blended mixture of milk, calcium caseinate S, water, and at least one food ingredient selected from the group consisting of coffee, cocoa, alcohol and food flavour; and
nitrogen.

23. The food product according to claim 22, wherein the milk has a cream fat content of about 0% to about 15% by weight.

24. The food product according to claim 22, wherein the milk has a cream fat content of about 7% to about 8% by weight.

25. The food product according to claim 22, wherein nitrogen is present in an amount of about 6 grams per liter of the blended mixture.

26. The food product according to claim 22, wherein the food flavour is selected from the group consisting of caramel, vanilla, honey, fruit, maple and mixtures thereof.

27. The food product according to claim 22, wherein the food ingredient is alcohol.

28. The food product according to claim 22, wherein the food product has an alcohol content between about 4% to about 12% by volume.
